(19) United States
(12) Patent Application Publication
(10) Pub. No.: US 2016/0285958 A1
(43) Pub. Date: Sep. 29, 2016

(54) APPLICATION CONTAINER FOR LIVE MIGRATION OF MOBILE APPLICATIONS

(71) Applicant: Intel Corporation, Santa Clara, CA (US)

(72) Inventors: Abhinav Das, San Jose, CA (US); Saurabh Shukla, Santa Clara, CA (US); Wei Li, Palo Alto, CA (US); Daniel M. Lavery, Cupertino, CA (US)

(21) Appl. No.: 14/671,680

(22) Filed: Mar. 27, 2015

(51) Int. Cl. H04L 29/08; G06F 9/455

(52) U.S. Cl. CPC H04L 67/10; G06F 9/45558; G06F 2009/4557; G06F 2009/45595

(57) ABSTRACT

Systems, apparatuses and methods may provide for isolating native information from non-native information, wherein the native information is associated with a mobile application running in a managed runtime environment. Additionally, the native information may be checkpointed and transferred from a first device to a second device in response to a live migration event. In one example, the native information includes native code and native state data and isolating the native information from the non-native information includes dispatching one or more native function calls to a binary translation (BT) container that manages a memory pool dedicated to the native information.

### TECHNICAL FIELD

Embodiments generally relate to application migration. More particularly, embodiments relate to application containers for live migration of mobile applications.

### BACKGROUND

Live migration of an application may involve the transfer of a running application from one platform (e.g., mobile device) to another (e.g., smart television/TV). Current live migration solutions may freeze the running application, checkpoint the application, the underlying operating system (OS) and/or virtual machine (VM) and all services upon which the application depends, and attempt to restore the checkpointed information on the other platform. Such an approach may therefore migrate information that is hardware specific such as, for example, graphics state information that is specific to each hardware implementation and its associated library code. As a result, conventional live migration tools may present challenges with regard to hardware compatibility across platforms. Indeed, excessive checkpointing may result in suboptimal performance for mobile devices that run on minimal hardware resources.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an operating system according to an embodiment;

FIGS. 2A and 2B are illustrations of an example of a memory layout of a conventional managed runtime and an example of a memory layout according to an embodiment, respectively;

FIG. 3 is a flowchart of an example of a method of migrating a live application according to an embodiment;

FIGS. 4A and 4B are flowcharts of examples of methods of operating a container according to an embodiment;

FIG. 5 is an illustration of an example of a set of a state rebuilding communications according to an embodiment;

FIG. 6 is a block diagram of an example of a migration of a container having a version mismatch according to an embodiment;

FIG. 7 is a block diagram of an example of a version mismatch solution according to an embodiment; and

FIG. 8 is a block diagram of an example of an application migration apparatus according to an embodiment.

### DESCRIPTION OF EMBODIMENTS

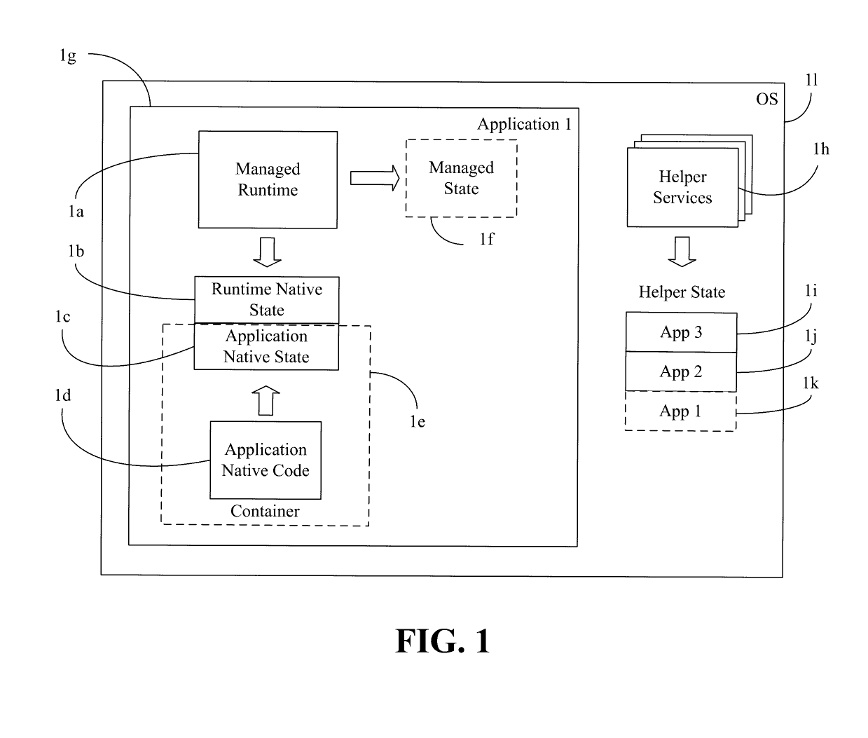

Turning now to FIG. 1, a mobile operating system (OS) 1l is shown running a mobile application 1g such as, for example, a game, media player, social networking application, and so forth, wherein the illustrated mobile application 1g includes a managed runtime environment 1a (e.g., “managed runtime”). In one example, the mobile application 1g is an ANDROID (GOOGLE, Inc.) application. The managed runtime environment 1a may be a high level solution such as, for example, HTML5 (Hypertext Markup Language 5, e.g., HTML5 Editor's Draft 8 May 2012, W3C), Dalvik (ANDROID Open Handset Alliance/OHA), ART (ANDROID Runtime, OHA), C# (e.g., C#5.0, MICROSOFT Corp., Aug. 15, 2012), .NET (e.g., .NET Framework 4.5, MICROSOFT Corp., Oct. 17, 2013), Ruby (e.g., Ruby 2.1.0, Y. Matsumoto, Dec. 25, 2013), Perl (e.g., Perl 5.18.2, Perl.org, Jan. 7, 2014), Python (e.g., Python 3.3.3, Python Software Foundation, Nov. 19, 2013), JAVA (e.g., JAVA Standard Edition 7 Update 51, ORACLE Corp., Jan. 14, 2014), etc., or other virtual machine (VM) that provides runtime compilation as an additional level of abstraction between the application layer and the OS 1l running with the managed runtime environment 1a.

During execution the illustrated mobile application 1g creates an application managed state 1f. Additionally, the managed runtime environment 1a may create a managed runtime native state 1b. The mobile application 1g may also include application native code 1d that creates native state data 1c (e.g., “native state”). In the illustrated example, the application native code 1d executes inside a container 1e that isolates the native code 1d and the native state data 1c from the managed runtime native state 1b (which may include hardware specific state data). The operating system 1l may also have a number of helper services 1h running, wherein the helper services 1h may interact with the mobile application 1g. The helper services 1h may save some helper state 1k pertaining to the mobile application 1g (in addition to helper state 1i, 1j, pertaining to other applications).

Thus, when a live migration event is detected, the managed runtime environment 1a may use a checkpointer (not shown) to checkpoint the managed state 1f, the container 1e may checkpoint the application native code 1d and the native state data 1c, and the helper services 1h may checkpoint the helper state 1k. The checkpointed state may be transferred to another device. Of particular note is that the managed runtime 1a may naturally support the rebuilding of the native state 1b on the new device without encountering hardware compatibility problems. Moreover, checkpointing only the application information in the container 1e rather than the full system may improve performance for mobile devices that run on minimal hardware resources. As will be discussed in greater detail, the container 1e may be a binary translation (BT) container that emulates and/or controls execution of the native code 1d.

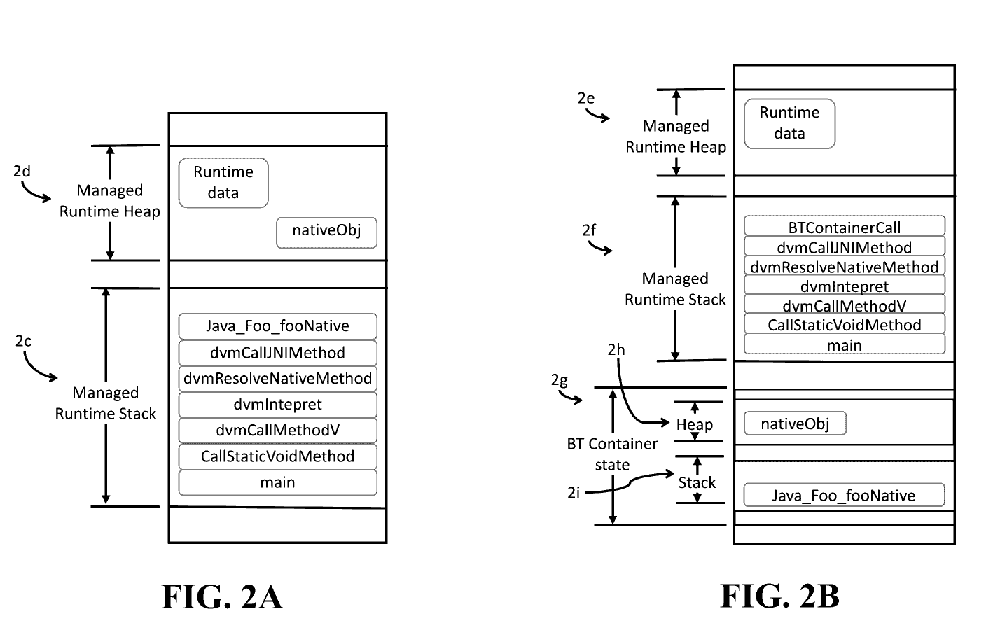

FIG. 2A shows a memory layout of a conventional managed runtime, such as, for example the managed runtime environment 1a (FIG. 1), that has dispatched a call into application native code, such as, for example the native code 1d (FIG. 1). Below is an example of application native code that is a function (e.g., “Java_Foo_fooNative”) in the C language that is allocating an object (e.g., “nativeObj”).

```
#include <Jni.h>
JNIEXPORT void JNICALL Java_Foo_fooNative
  (JNIEnv *env, jobject clazz)
{
      void *nativeObj = malloc(size);
}
```

As shown in FIG. 2A, a managed runtime stack 2c holds the stack frames for the runtime and the stack frame for the Java_Foo_fooNative function. A managed runtime heap 2d holds the data allocated by the runtime and also the object allocated by the Java_Foo_fooNative function. A problem with the illustrated conventional solution is that the runtime's native state (stack and heap) is not isolated from the application's native state (stack and heap). By contrast, FIG. 2B demonstrates that isolation of the managed runtime native state and the application native state may be achieved by emulating the application native code 1d (FIG. 1) in a BT container. The BT container may manage a native region 2g for its own state, wherein the illustrated region 2g includes space for a stack 2i and a heap 2h. Instead of calling the Java_Foo_fooNative function, the managed runtime calls “BTContainerCall” as shown in the managed runtime stack 2f The function BTContainerCall may begin emulation of Java_Foo_fooNative, which results in allocation of nativeObj in the BT container heap 2h. A managed runtime heap 2e may continue to store runtime data. Thus, the application native state associated with a running mobile application is isolated from the managed runtime's native state as shown in the illustrated example.

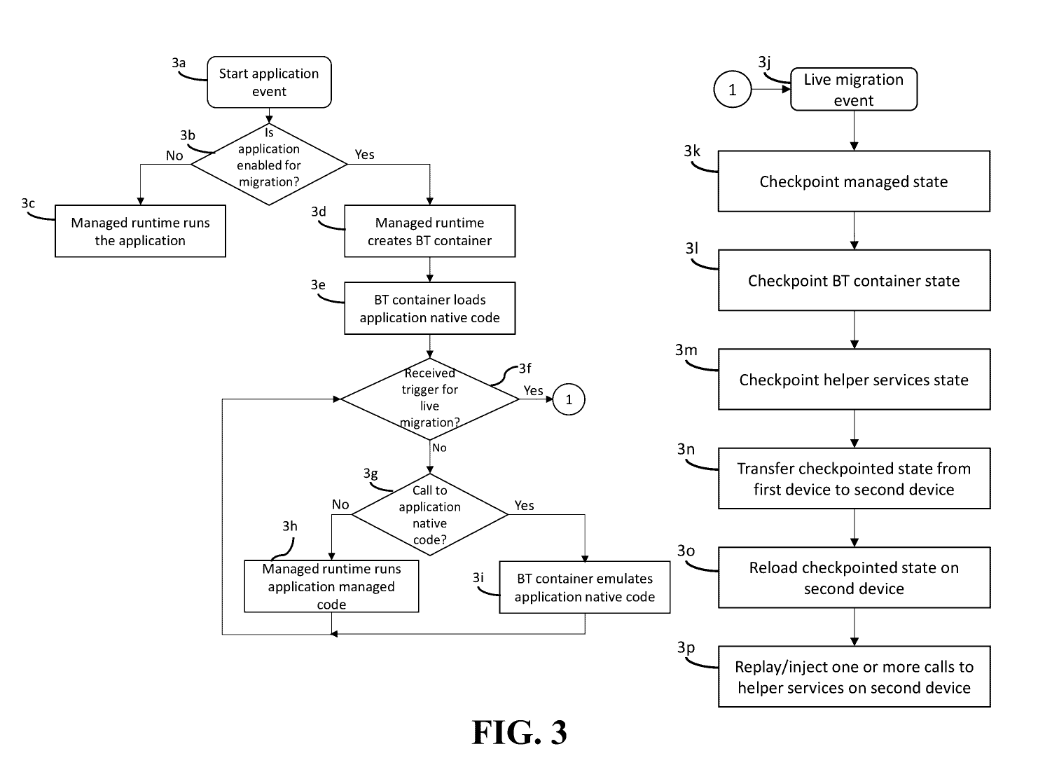

Turning now to FIG. 3, a method 3a of starting and running a mobile application enabled for live application is shown and a method 3j of migrating application state from a first device to second device is shown. The methods 3a and 3j may be a mechanism implemented as one or more modules in a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof. For example, computer program code to carry out operations shown in methods 3a and 3j may be written in any combination of one or more programming languages, including an object oriented programming language such as C#, JAVA or the like.

FIG. 3 generally illustrates the process of isolating native information from managed runtime native information. The native information may be associated with a mobile application running in a managed runtime environment and the mobile application may be identified at processing block 3b as a live migration candidate, wherein applications that are not enabled for migration may be run by the managed runtime at block 3c. The native information may include native code and native state data. As will be discussed in greater detail, block 3g may include dispatching one or more native function calls (e.g., the Java_Foo_fooNative function discussed above) to a binary translation (BT) container that manages resources (e.g., including stack and heap allocations), wherein the resources are dedicated to the application native information (e.g., the resources include a memory pool that excludes the managed runtime native information and application managed state). Thus, the memory pool may include a native region such as, for example, the native region 2g (FIG. 2), already discussed. Block 3d may also include passing one or more wrapper function pointers to the BT container, wherein the one or more wrapper function pointers correspond to one or more managed runtime functions (e.g., JAVA Native Interface/JNI functions). The wrapper function pointers may generally cause the BT container to suspend container-controlled execution (e.g., emulation) and call the corresponding one or more managed runtime functions. Illustrated block 3e provides for using the BT container to load the application native code.

A determination may be made at block 3f as to whether a live migration event has occurred. The live migration event might include, for example, an interrupt, request, message or other condition change associated with the transfer of the mobile application from a first device to the second device while the mobile application is running. Thus, the mobile application may be a game being played by a user on a tablet computer, wherein the user might issue a request (e.g., by pressing a button, shaking the tablet computer, speaking a command, etc.) to migrate the game to a smart TV while keeping the game in its current state (e.g., not having to start the game over). If a live migration event is not detected at block 3f, the running of the application continues at block 3h after which the determination of live migration event is again performed. More particularly, a determination may be made at block 3g as to whether a call to application native code has been made. If so, the BT container may emulate the application native code at block 3i. Otherwise, illustrated block 3h provides for using the managed runtime to run application managed code, as already noted.

If a live migration event is detected, illustrated blocks 3k, 3l and 3m checkpoint managed state, BT container state, and helper services state, respectively. Block 3n may transfer the checkpointed native information from a first (e.g., originating) device to a second (e.g., destination) device. Block 3n may include transmitting (e.g., via wireless and/or wired communication) the checkpointed native information directly to the second device, requesting a remote device and/or server to transmit the checkpointed native information to the second device, and so forth. Illustrated block 3o reloads the transferred state on the second device. One or more calls (e.g., a sequence of ten calls made while the mobile application is running on the first device) to helper services may be replayed on the second device at block 3p, wherein replaying the calls may enable the helper services running on the second device to rebuild the state of the mobile application.

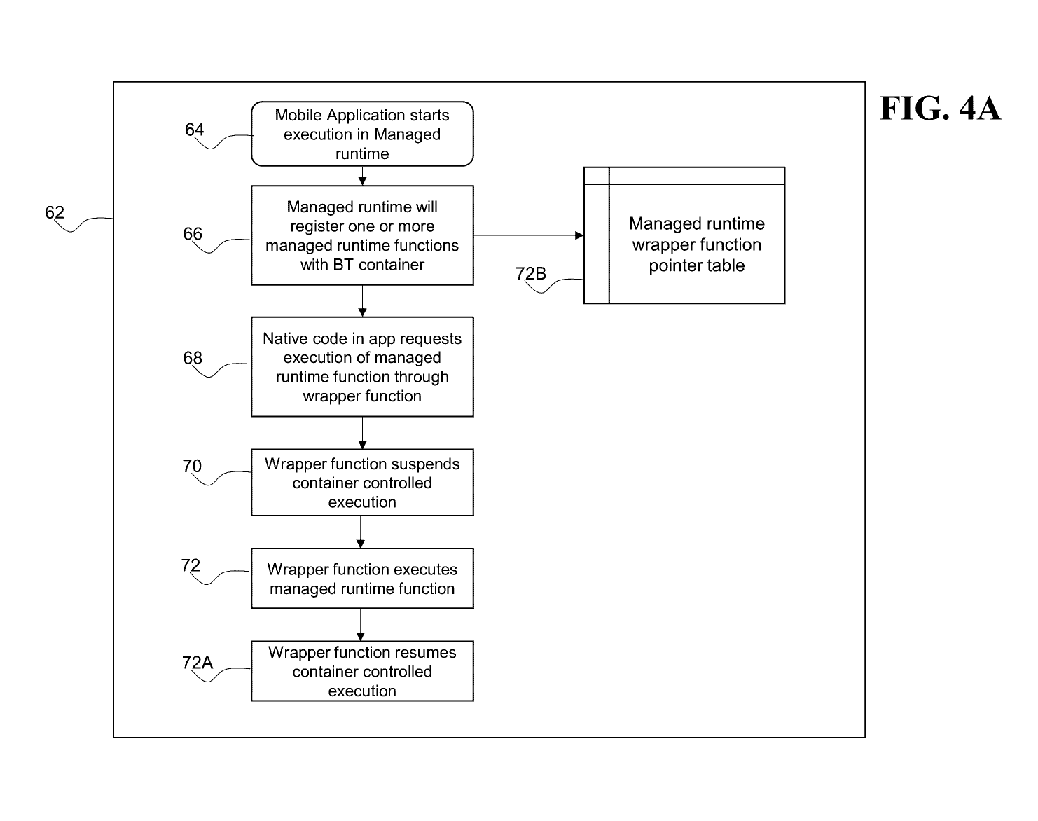

FIGS. 4A and 4B show methods 62 and 63, respectively, of operating a container. The methods 62 and 63 may generally be a mechanism implemented in an application container such as, for example, the application container 1e (FIG. 1), already discussed. More particularly, the methods 62 and 63 may be implemented as one or more modules in a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS or TTL technology, or any combination thereof.

As already noted, the container may be implemented as a BT container that generally isolates the execution of the application native code from the managed runtime code and isolates the application native state data from the managed runtime native state data. One or more managed runtime functions may be registered with the BT container by means of providing wrapper functions for each of those managed runtime functions. With regard to FIG. 4A, a mobile application starts execution in managed runtime at block 64 and illustrated block 66 provides for receiving/registering one or more wrapper function pointers corresponding to one or more managed runtime functions via a managed runtime wrapper function table 72B. When native application code requests execution of one or more managed runtime functions at illustrated block 68, container-controlled execution of application native code may be suspended at block 70. Block 72 may call the corresponding one or more managed runtime functions and pass returned values back to the container code. Container-controlled execution may resume at block 72A.

With regard to FIG. 4B, a mobile application may start execution of a managed runtime at block 65 and illustrated block 67 detects an attempt by native code in the container to load a hardware (HW) specific library. The container may load a wrapper library that is interface equivalent to the HW specific library inside the container, as illustrated in block 69. The application may continue execution and in the future may request one or more functions in the HW specific library at block 71. Container-controlled execution (e.g., emulation) may be suspended at block 73 by the wrapper library function and the actual HW specific library function is called as illustrated in block 75. Illustrated block 77 passes returned values back to the native code in the container and resumes container-controlled execution.

In general, the illustrated method 63 takes into consideration the hardware differences between two devices involved in a live application migration. More particularly, processing block 75 may call one or more hardware specific functions outside the container. As an example, the BT container may detect when the application native code tries to load a hardware specific graphics library such as, for example, the OpenGL library “libEGL.so”, and instead load “libEGL-wrapper.so”. The wrapper library will have the same functions defined in the original library. Accordingly, when the emulated code calls any one of the wrapper functions, the BT container may suspend emulation and transfer control to the managed runtime, which calls the corresponding function in the hardware specific library. When the function returns, the BT container may pass the returned value back to the emulated code and resume emulation.

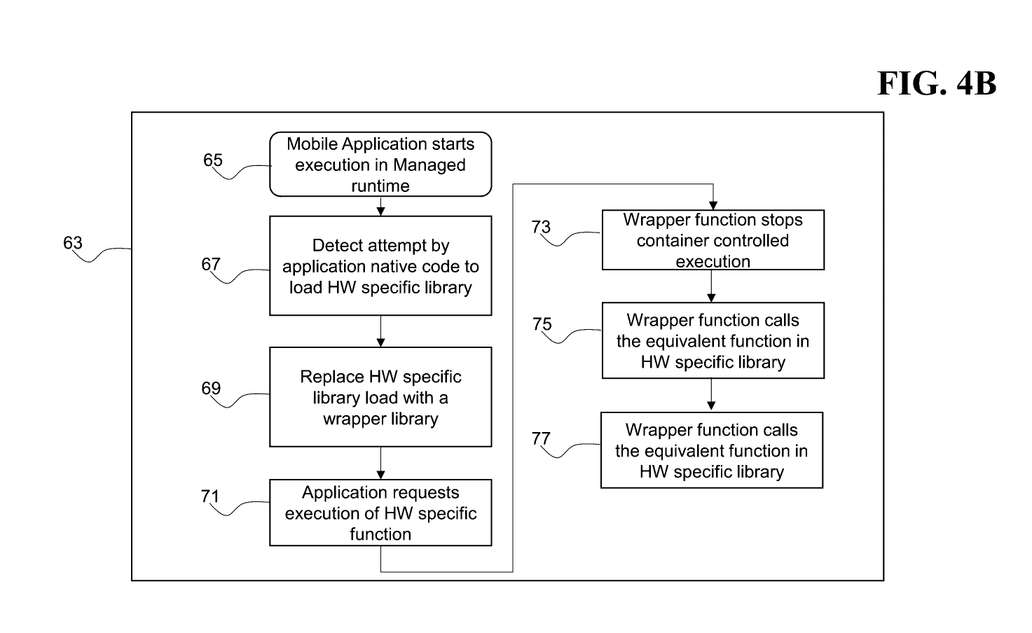

Turning now to FIG. 5, a set of state rebuilding communications is shown for application state residing in helper services that are usually system defined services. In the illustrated example, prior to migration, a mobile application 82 running on a first device (“Device 1”) issues a series of function calls 84A and 84B that create state 84C and 84D, respectively, in a helper service 86. A trigger 85 may initiate migration of the application 82 from Device 1 to a second device (“Device 2”), which already has its own helper service 86 running. After migration to Device 2, the illustrated mobile application 82 regenerates state in the helper service 86 of Device 2 so that the helper service 86 can continue to provide support for the application 82 on Device 2. The helper service may be modified to add support for this functionality with a new API (application programming interface) call 88 (e.g., “funcInjectState”). During application initialization, the new API that is called may regenerate state using a replay of “Func1( )” and “Func2( )” calls or a direct transfer/copy of the state 84D from Device 1 to Device 2. In one example, an ANDROID OS has several helper services such as Activity Manager, Window Manager and others that may be modified to support the new API call for state injection as described herein.

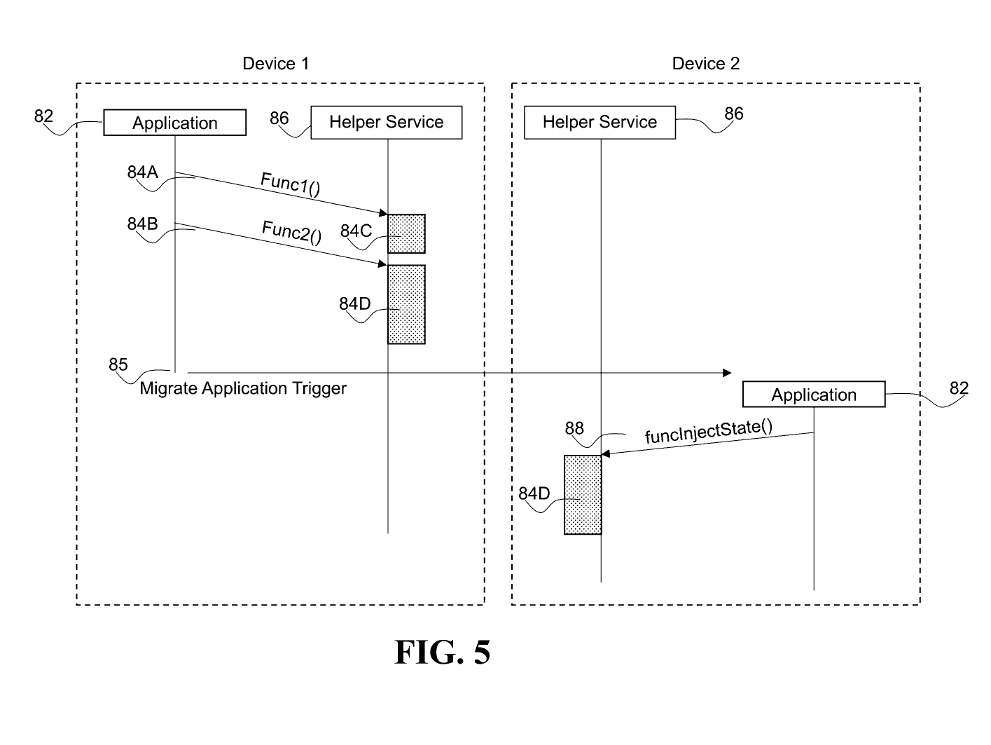

FIG. 6 shows a live migration 96 of a particular version level (e.g., version four/V4) container 90 (90a, 90b) having a version mismatch after migration. In the illustrated example, the container 90 includes a V4 support library 90a that interacts with a V4 hardware abstraction layer (HAL) 90b (e.g., container interface). The illustrated HAL 90b is a layer of software that connects applications with HW specific libraries such as those required for graphics, audio, sensors, etc., using a well-defined API. The illustrated V4 HAL 90b in turn interacts with a V4 hardware (HW) library 92 on a V4 mobile device prior to migration. After the live migration 96 of the V4 container 90 to a higher version level (e.g., version five/V5) mobile device having a V5 HW library 94, the V4 container 90 uses a V4-V5 HAL “Glue Layer” 98 to interact with the V5 HW library 94. In particular, a migration apparatus will detect the version mismatch between the first device (e.g., the V4 mobile device) and the second device (e.g., the V5 mobile device). The migration apparatus on the V5 mobile device will then load the application in a V4 container 90 on the V5 mobile device. One or more hardware specific calls will go through the HAL of V4, which will now communicate with the V4-V5 glue layer 98 before communicating with V5 HW library 94. Libraries and code are also maintained in a sub-path where version dependencies are satisfied as per requirements of the V4 mobile device. For example, if V4 code attempts to load a library such as, for example, “libfoo.so”, instead of loading the library from the sub-path “/system/lib/libfoo.so”, the library may be loaded from “/v4/system/lib/libfoo.so”. Thus, the illustrated V4 container 90 provides a convenient separation for HAL libraries that may have symbol dependencies with specific versions of the mobile application.

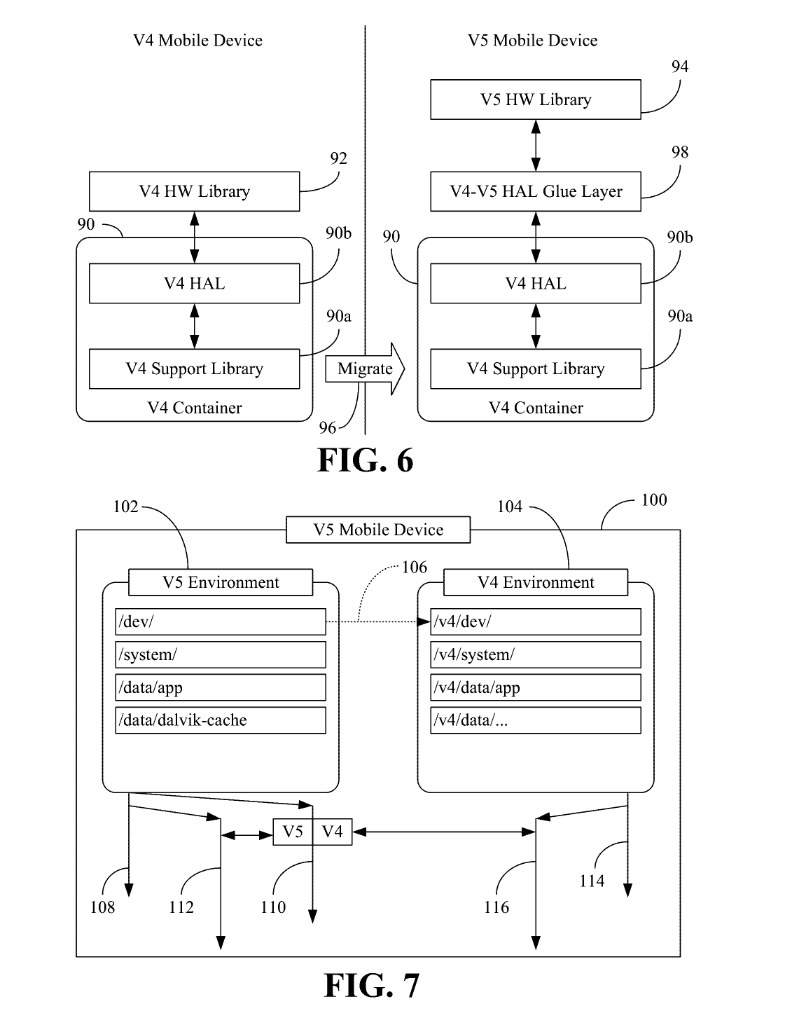

FIG. 7 shows a version mismatch solution for a migrated application when it communicates with helper services on the V5 mobile device. Helper services (such as, for example, system services) are generally not duplicated as they hold HW resources and other system-wide resources. A V5 mobile device 100 may therefore include both a V5 environment 102 (e.g., V5 JAVA virtual machine) and a V4 environment 104 (e.g., V4 JAVA virtual machine) to support live migration of applications from a V4 device. The V5 environment 102 may include a sub-path structure that maps 106 to a corresponding sub-path structure in the V4 environment 104. The V5 environment 102 may also include an application launcher 108 (e.g., Zygote daemon in the case of ANDROID) that launches system-wide services, such as an activity manager 110 in the case of ANDROID, as well as one or more mobile applications 112 (e.g., Application #1). The illustrated activity manager 110 has been modified to support both the V4 API (application programming interface) and the V5 API. The V4 environment 104 also has an application launcher 114 to launch applications that have live migrated from V4 device. A V4 application 116 will communicate with system-wide services, such as the activity manager 110. The activity manager 110 and other helper services may be modified to support the V4 API and the application 116 will communicate on this interface. The V5 applications will communicate on the V5 API and these helper services will maintain state of V4 and V5 applications, in the illustrated example.

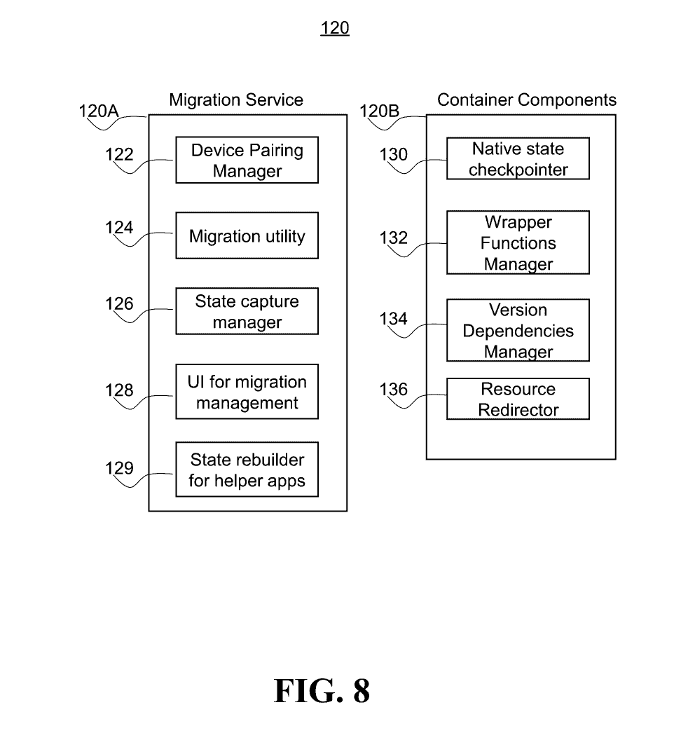

FIG. 8 shows an application migration apparatus 120 (120A-120B). The application migration apparatus 120 may perform one or more aspects of methods in FIG. 3, already discussed. In the illustrated example, a mechanism such as a set of container components 120B isolate native information from managed runtime information, wherein the native information is associated with a mobile application running in a managed runtime environment. The illustrated set of container components 120B includes a checkpointer 130 to checkpoint the native application information and send this to a migration service 120A (e.g., a migrator), wherein the migration service 120A may transfer the checkpointed native information from a first device to a second device in response to a live migration event. The illustrated set of container components 120B also includes a wrapper function manager 132 to dispatch one or more managed runtime and HW specific calls to functions in the mobile operating environment outside the container after suspending container controlled execution. In one example, the migration service 120A includes a state rebuilder 129 to build state of migrated application by replaying one or more calls to helper services on the second device or by injecting state directly into these helper services.

As already noted, the native information may also include version data. The set of container components 120B may therefore also include a version dependencies manager 134 to detect a mismatch between the first device and the second device, wherein a resource redirector 136 may redirect one or more resource specific calls to a resource sub-path where version dependencies are maintained. The illustrated migration service 120A also includes a pairing manager 122 to maintain paired devices that support migration, a migration utility 124 to enable transfer of state from one device to another and a state capture manager 126. The state capture manager 126 may be responsible for collecting application state from various parts of the system, serializing it and sending it to the migration utility. A user interface (UI) 128 for migration may enable the user to visualize the migration at various points of migration, as well as to enable and disable migration of applications and trigger/cancel migration.

Thus, techniques described herein may identify state data relevant for migration and isolate it so that it may be easily checkpointed. The checkpointed state may then be transferred to another device, where after reloading the checkpointed state into memory and re-initializing (using replay) if needed, the mobile application may restart from precisely the same point where it was checkpointed. In one example, binary translation is used to identify and isolate the mobile application's native code and state and ANDROID framework support may be used to re-initialize libraries and rebuild state in helper services.

### Additional Notes and Examples

Example 1 an application migration apparatus comprising a mechanism to isolate native information from managed runtime information, wherein the native information is to be associated with a mobile application running in a managed runtime environment, a first checkpointer to checkpoint the native information, and a migrator to transfer the checkpointed native information from a first device to a second device in response to a live migration event.

Example 2 may include the apparatus of Example 1, wherein the native information is to include native code and native state data and the apparatus further includes a container interface to dispatch one or more native function calls to a binary translation container that manages resources dedicated to the native information.

Example 3 may include the apparatus of Example 2, wherein the container interface is to pass one or more wrapper function pointers to the binary translation container, and wherein the one or more wrapper function pointers are to correspond to one or more managed runtime functions.

Example 4 may include the apparatus of Example 3, wherein the one or more wrapper function pointers are to cause the binary translation container to suspend container-controlled execution and call the corresponding one or more managed runtime functions.

Example 5 may include the apparatus of Example 2, wherein the container further includes a wrapper function to call one or more hardware specific functions outside the binary translation container, wherein the container interface is to receive one or more wrapper function pointers from a mobile operating environment, and a wrapper manager to manage functions of hardware dependent libraries and their associated resources.

Example 6 may include the apparatus of Example 1, further including a state rebuilder to replay or inject one or more calls to helper services on the second device.

Example 7 may include the apparatus of Example 1, further including a second checkpointer to checkpoint application managed state, wherein the migrator is to migrate the application managed state.

Example 8 may include the apparatus of Example 1, wherein the native information is to include version data and the apparatus further includes a version dependency manager to detect a mismatch between the first device and the second device based on the version data, and a resource redirector to redirect one or more hardware specific calls to a sub-path where version dependencies are maintained, wherein one or more helper services include modifications to recognize and interact with applications that have a version mismatch with a current device.

Example 9 may include the method of any one of Examples 1 to 8, wherein the mobile application is to include an ANDROID application and the managed runtime environment is to include a JAVA virtual machine.

Example 10 may include a method of migrating live applications, comprising isolating native information from managed runtime information, wherein the native information is associated with a mobile application running in a managed runtime environment, checkpointing the native information, and transferring the checkpointed native information from a first device to a second device in response to a live migration event.

Example 11 may include the method of Example 10, wherein the native information includes native code and native state data and the method further includes dispatching one or more native function calls to a binary translation container that manages resources dedicated to the native information.

Example 12 may include the method of Example 11, further including passing one or more wrapper function pointers to the binary translation container, wherein the one or more wrapper function pointers correspond to one or more managed runtime functions.

Example 13 may include the method of Example 12, wherein the one or more wrapper function pointers cause the binary translation container to suspend container-controlled execution and call the corresponding one or more managed runtime functions.

Example 14 may include the method of Example 11, further including calling one or more hardware specific functions outside the binary translation container, receiving one or more wrapper function pointers from a mobile operating environment, and managing functions of hardware dependent libraries and their associated resources.

Example 15 may include the method of Example 10, further including replaying or injecting one or more calls to helper services on the second device.

Example 16 may include the method of Example 10, wherein the native information includes version data and the method further includes detecting a version mismatch between the first device and the second device based on the version data, and redirecting one or more hardware specific calls to a sub-path where version dependencies are maintained, wherein one or more helper services include modifications to recognize and interact with applications that have a version mismatch with a current device.

Example 17 may include the method of any one of Examples 10 to 16, wherein the mobile application includes an ANDROID application and the managed runtime environment includes a JAVA virtual machine.

Example 18 may include at least one computer readable storage medium comprising a set of instructions which, when executed by a processor, cause the processor to isolate native information from managed runtime information, wherein the native information is to be associated with a mobile application running in a managed runtime environment, checkpoint the native information, and transfer the checkpointed native information from a first device to a second device in response to a live migration event.

Example 19 may include the at least one computer readable storage medium of Example 18, wherein the native information is to include native code and native state data and the instructions, when executed, further causes a processor to dispatch one or more native function calls to a binary translation container that manages resources dedicated to the native information.

Example 20 may include the at least one computer readable storage medium of Example 19, wherein the instructions, when executed, cause a processor to pass one or more wrapper function pointers to the binary translation container, and wherein the one or more wrapper function pointers are to correspond to one or more managed runtime functions.

Example 21 may include the at least one computer readable storage medium of Example 20, wherein the one or more wrapper function pointers are to cause the binary translation container to suspend container-controlled execution and call the corresponding one or more managed runtime functions.

Example 22 may include the at least one computer readable storage medium of Example 19, wherein the instructions, when executed, cause a processor to call one or more hardware specific functions outside the binary translation container, receive one or more wrapper function pointers from a mobile operating environment, and manage functions of hardware dependent libraries and their associated resources.

Example 23 may include the at least one computer readable storage medium of Example 18, wherein the instructions, when executed, cause a processor to replay or inject one or more calls to helper services on the second device.

Example 24 may include the at least one computer readable storage medium of Example 18, wherein the native information is to include version data and the instructions, when executed, cause a processor to detect a version mismatch between the first device and the second device based on the version data, and redirect one or more hardware specific calls to a sub-path where version dependencies are maintained, wherein one or more helper services include modifications to recognize and interact with applications that have a version mismatch with a current device.

Example 25 may include the at least one computer readable storage medium of any one of Examples 18 to 24, wherein the mobile application is to include an ANDROID application and the managed runtime environment is to include a JAVA virtual machine.

Example 26 may include an application migration apparatus comprising means for isolating native information from managed runtime information, wherein the native information is associated with a mobile application running in a managed runtime environment, means for checkpointing the native information, and means for transferring the checkpointed native information from a first device to a second device in response to a live migration event.

Example 27 may include the apparatus of Example 26, wherein the native information is to include native code and native state data and the apparatus further includes means for dispatching one or more native function calls to a binary translation container that manages resources dedicated to the native information.

Example 28 may include the apparatus of Example 27, further including means for passing one or more wrapper function pointers to the binary translation container, wherein the one or more wrapper function pointers are to correspond to one or more managed runtime functions.

Example 29 may include the apparatus of Example 28, wherein the one or more wrapper function pointers are to cause the binary translation container to suspend container-controlled execution and call the corresponding one or more managed runtime functions.

Example 30 may include the apparatus of Example 27, further including means for calling one or more hardware specific functions outside the binary translation container, means for receiving one or more wrapper function pointers from a mobile operating environment, and means for managing functions of hardware dependent libraries and their associated resources.

Example 31 may include the apparatus of Example 26, further including means for replaying or injecting one or more calls to helper services on the second device.

Example 32 may include the apparatus of Example 26, wherein the native information is to include version data and the apparatus further includes means for detecting a version mismatch between the first device and the second device based on the version data, and means for redirecting one or more hardware specific calls to a sub-path where version dependencies are maintained, wherein one or more helper services include modifications to recognize and interact with applications that have a version mismatch with a current device.

Example 33 may include the apparatus of any one of Examples 26 to 32, wherein the mobile application is to include an ANDROID application and the managed runtime environment is to include a JAVA virtual machine.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A, B, C, A and B, A and C, B and C, or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An apparatus comprising:
a mechanism to isolate native information from managed runtime information; wherein the native information is to be associated with a mobile application running in a managed runtime environment;
a first checkpointer to checkpoint the native information; and
a migrator to transfer the checkpointed native information from a first device to a second device in response to a live migration event.

2. The apparatus of claim 1, wherein the native information is to include native code and native state data and the apparatus further includes a container interface to dispatch one or more native function calls to a binary translation container that manages resources dedicated to the native information.

3. The apparatus of claim 2, wherein the container interface is to pass one or more wrapper function pointers to the binary translation container, and wherein the one or more wrapper function pointers are to correspond to one or more managed runtime functions.

4. The apparatus of claim 3, wherein the one or more wrapper function pointers are to cause the binary translation container to suspend container-controlled execution and call the corresponding one or more managed runtime functions.

5. The apparatus of claim 2, wherein the container further includes:
a wrapper function to call one or more hardware specific functions outside the binary translation container, wherein the container interface is to receive one or more wrapper function pointers from a mobile operating environment; and
a wrapper manager to manage functions of hardware dependent libraries and their associated resources.

6. The apparatus of claim 1, further including a state rebuilder to replay or inject one or more calls to helper services on the second device.

7. The apparatus of claim 1, further including a second checkpointer to checkpoint application managed state, wherein the migrator is to migrate the application managed state.

8. The apparatus of claim 1, wherein the native information is to include version data and the apparatus further includes:
a version dependency manager to detect a mismatch between the first device and the second device based on the version data; and
a resource redirector to redirect one or more hardware specific calls to a sub-path where version dependencies are maintained, wherein one or more helper services include modifications to recognize and interact with applications that have a version mismatch with a current device.

9. The apparatus of claim 1, wherein the mobile application is to include an ANDROID application and the managed runtime environment is to include a JAVA virtual machine.

10. A method comprising:
isolating native information from non-native information, wherein the native information is associated with a mobile application running in a managed runtime environment;
checkpointing the native information; and
transferring the checkpointed native information from a first device to a second device in response to a live migration event.

11. The method of claim 10, wherein the native information includes native code and native state data and the method further includes dispatching one or more native function calls to a binary translation container that manages a memory pool dedicated to the native information.

12. The method of claim 11, further including passing one or more wrapper function pointers to the binary translation container, wherein the one or more wrapper function pointers correspond to one or more managed runtime functions.

13. The method of claim 12, wherein the one or more wrapper function pointers cause the binary translation container to suspend container-controlled execution and call the corresponding one or more managed runtime functions.

14. The method of claim 11, further including:
calling one or more hardware specific functions outside the binary translation container;
receiving one or more wrapper function pointers from the binary translation container; and
using one or more hardware specific libraries to call the one or more wrapper function pointers.

15. The method of claim 10, further including replaying one or more calls to helper services on the second device.

16. The method of claim 10, wherein the native information includes version data and the method further includes:
detecting a version mismatch between the first device and the second device based on the version data;
redirecting one or more hardware specific calls to a sub-path where version dependencies are maintained; and
managing backward compatibility communications with one or more helper services running on the second device.

17. The method of claim 10, wherein the mobile application includes an ANDROID application and the managed runtime environment includes a JAVA virtual machine.

18. At least one computer readable storage medium comprising a set of instructions which, when executed by a processor, cause the processor to:
isolate native information from non-native information, wherein the native information is to be associated with a mobile application running in a managed runtime environment;
checkpoint the native information; and
transfer the checkpointed native information from a first device to a second device in response to a live migration event.

19. The at least one computer readable storage medium of claim 18, wherein the native information is to include native code and native state data and the instructions, when executed, further causes a processor to dispatch one or more native function calls to a binary translation container that manages a memory pool dedicated to the native information.

20. The at least one computer readable storage medium of claim 19, wherein the instructions, when executed, cause a processor to pass one or more wrapper function pointers to the binary translation container, and wherein the one or more wrapper function pointers are to correspond to one or more managed runtime functions.

21. The at least one computer readable storage medium of claim 20, wherein the one or more wrapper function pointers are to cause the binary translation container to suspend container-controlled execution and call the corresponding one or more managed runtime functions.

22. The at least one computer readable storage medium of claim 19, wherein the instructions, when executed, cause a processor to:
call one or more hardware specific functions outside the binary translation container;
receive one or more wrapper function pointers from the binary translation container; and
use one or more hardware specific libraries to call the one or more wrapper function pointers.

23. The at least one computer readable storage medium of claim 18, wherein the instructions, when executed, cause a processor to replay one or more calls to helper services on the second device.

24. The at least one computer readable storage medium of claim 18, wherein the native information is to include version data and the instructions, when executed, cause a processor to:
detect a version mismatch between the first device and the second device based on the version data;
redirect one or more hardware specific calls to a sub-path where version dependencies are maintained; and
manage backward compatibility communications with one or more helper services running on the second device.

25. The at least one computer readable storage medium of claim 18, wherein the mobile application is to include an ANDROID application and the managed runtime environment is to include a JAVA virtual machine.
